(19) United States
(12) Patent Application Publication
(10) Pub. No.: US 2016/0203621 A1
(43) Pub. Date: Jul. 14, 2016

(54) MEDICAL DIAGNOSTIC IMAGING APPARATUS, IMAGE PROCESSING APPARATUS AND IMAGE PROCESSING METHOD

(71) Applicants: Kabushiki Kaisha Toshiba, Minato-ku (JP); Toshiba Medical Systems Corporation, Otawara-shi (JP)

(72) Inventors: Masatoshi SEKI, Nasushiobara (JP); Kazumasa ARAKITA, Nasushiobara (JP)

(73) Assignees: Kabushiki Kaisha Toshiba, Minato-ku (JP); Toshiba Medical Systems Corporation, Otawara-shi (JP)

(21) Appl. No.: 14/990,157

(22) Filed: Jan. 7, 2016

(30) Foreign Application Priority Data
Jan. 9, 2015 (JP) 2015-003510
Nov. 24, 2015 (JP) 2015-229122

(51) Int. Cl. G06T 11/00; G06T 7/00

(52) U.S. Cl. CPC G06T 11/008; G06T 7/0014; G06T 2207/10104; G06T 2207/20221; G06T 2207/20036; G06T 2207/30048

(57) ABSTRACT

A medical diagnostic imaging apparatus according to an embodiment includes morphological image data collecting circuitry, displacement calculating circuitry, functional image data collecting circuitry, and correction circuitry. The morphological image data collecting circuitry collects pieces of morphological image data of a target region at a plurality of time phases. Based on a plurality of the collected pieces of morphological image data, the displacement calculating circuitry calculates displacements of morphological image regions contained in the collected pieces of morphological image data. The functional image data collecting circuitry collects functional image data of the target region. The correction circuitry generates, based on the displacements calculated by the displacement calculating circuitry, corrected image data corrected for motion of the target region.

### CROSS-REFERENCE TO RELATED APPLICATIONS

This application is based upon and claims the benefit of priority from Japanese Patent Application No. 2015-003510, filed on Jan. 9, 2015; and Japanese Patent Application No. 2015-229122, filed on Nov. 24, 2015 the entire contents of all of which are incorporated herein by reference.

### FIELD

Embodiments described herein relate generally to a medical diagnostic imaging apparatus, an image processing apparatus, and an image processing method.

### BACKGROUND

In the field of medical diagnostic imaging apparatuses, an apparatus formed by integrating an apparatus for capturing morphological images of a subject and an apparatus for capturing functional images of a subject has been put into practical use. Examples of an apparatus for capturing morphological images of a subject include an X-ray computed tomography (CT) apparatus and a magnetic resonance imaging (MRI) apparatus. Examples of an apparatus for capturing functional images of a subject include a nuclear medicine imaging apparatus. Examples of a nuclear medicine imaging apparatus include a positron emission tomography (PET) apparatus, and a single photon emission computed tomography (SPECT) apparatus.

However, it may take a long time for a nuclear medicine imaging apparatus to capture a functional image. For this reason, a functional image may be affected by motion of a target region.

At present, for example, a PET-CT apparatus is known that corrects motions of PET images captured at respective phases of a biosignal by deforming, in accordance with a CT image captured while a subject holds his or her breath, the PET images captured at the respective phases of the biosignal.

### BRIEF DESCRIPTION OF THE DRAWINGS

FIG. 1 is a diagram illustrating a medical diagnostic imaging apparatus according to a first embodiment;

FIG. 2 is a diagram illustrating an exemplary configuration of the medical diagnostic imaging apparatus according to the first embodiment;

FIG. 3 is a diagram illustrating an exemplary configuration of a morphological image generating unit according to the first embodiment;

FIG. 4 is a diagram illustrating an exemplary configuration of a functional image generating unit according to the first embodiment;

FIG. 5 is a diagram illustrating an exemplary configuration of a processing unit according to the first embodiment;

FIG. 6 is a diagram illustrating an exemplary configuration of a synthesis unit according to the first embodiment;

FIG. 7 is a flowchart illustrating exemplary processing in the medical diagnostic imaging apparatus according to the first embodiment;

FIG. 8 is a diagram for explaining the relation between morphological images captured by the morphological image capturing unit and a signal obtained by a signal acquiring unit, according to the first embodiment;

FIG. 9 is a diagram illustrating correction data produced by a displacement calculating unit according to the first embodiment;

FIG. 10 is a diagram for explaining a procedure in accordance with which a correction unit according to the first embodiment corrects the positions of a plurality of functional image regions contained in a functional image;

FIG. 11 is a diagram for explaining a respiration signal acquired by a signal acquiring unit according to a second embodiment;

FIG. 12 is a diagram for explaining the relation between morphological images captured by a morphological image capturing unit according to the second embodiment and a signal obtained by the signal acquiring unit;

FIG. 13 is a diagram for explaining a procedure in accordance with which a correction unit according to a third embodiment generates a corrected image data;

FIG. 14 is a diagram illustrating one example of a singularly changed electrocardiographic signal; and

FIG. 15 is a diagram illustrating another example of a singularly changed electrocardiographic signal.

### DETAILED DESCRIPTION

A medical diagnostic imaging apparatus according to an embodiment includes morphological image data collecting circuitry, displacement calculating circuitry, functional image data collecting circuitry, and correction circuitry. The morphological image data collecting circuitry collects pieces of morphological image data of a target region at a plurality of time phases. Based on a plurality of the collected pieces of morphological image data, the displacement calculating circuitry calculates displacements of morphological image regions contained in the collected pieces of morphological image data. The functional image data collecting circuitry collects functional image data of the target region. The correction circuitry generates, based on the displacements calculated by the displacement calculating circuitry, corrected image data corrected for motion of the target region.

The following describes the medical diagnostic imaging apparatus, the image processing apparatus, and the image processing method according to the embodiments with reference to the drawings. Duplicated explanations are omitted as appropriate in the following embodiments.

### First Embodiment

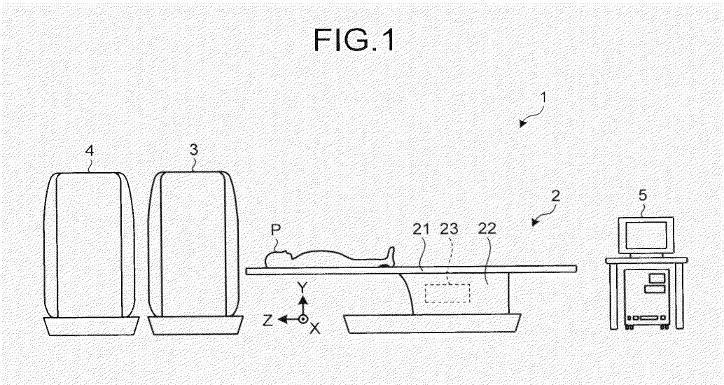

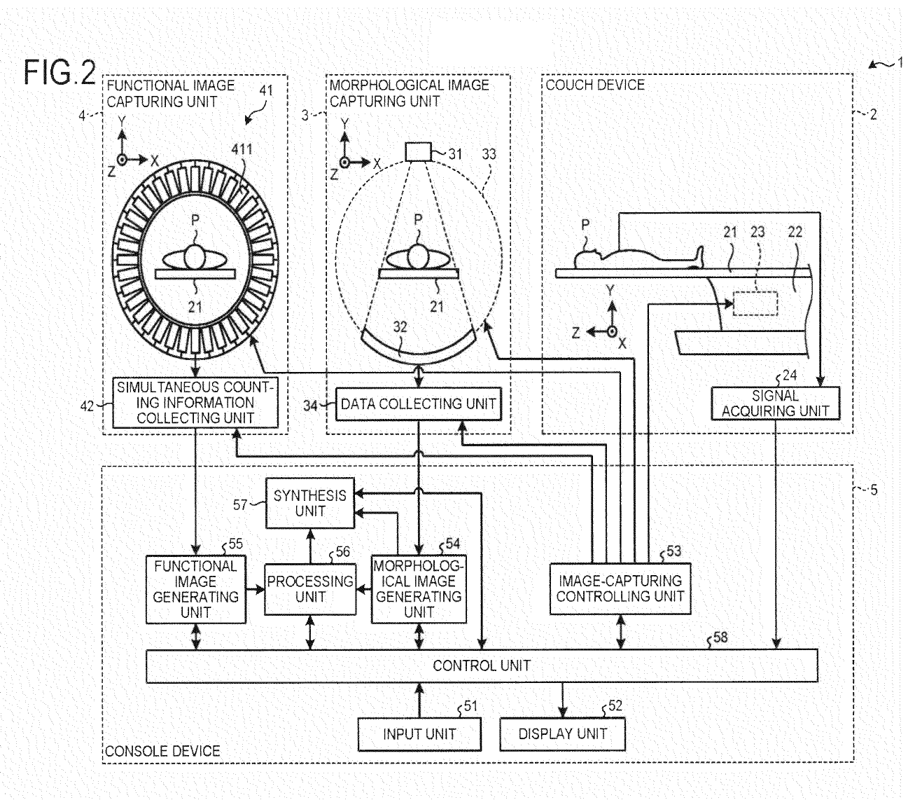

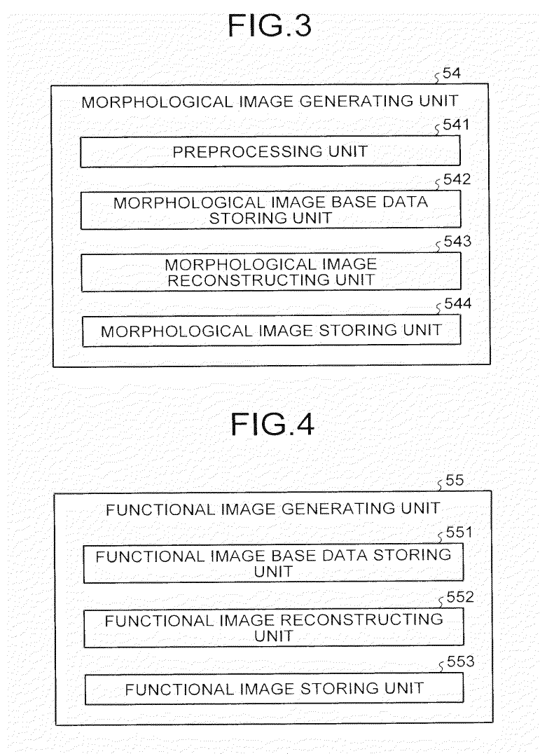

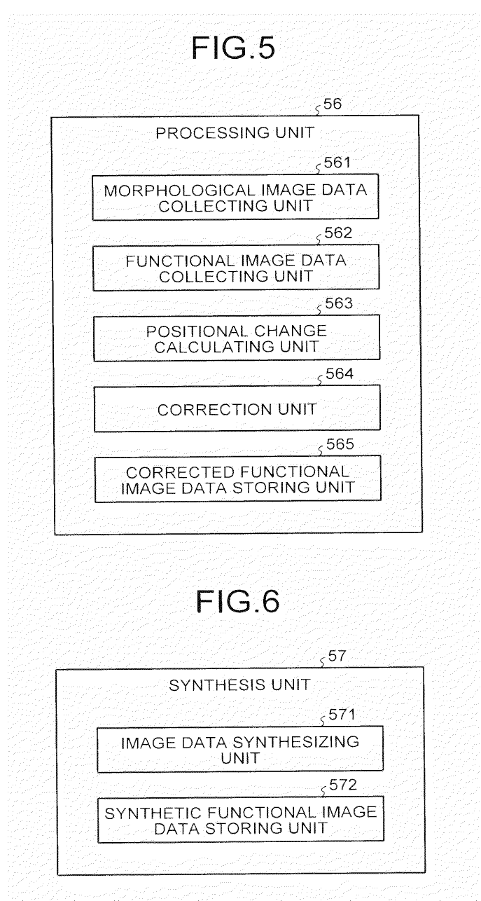

Firstly, a medical diagnostic imaging apparatus 1 according to a first embodiment is described with reference to FIG. 1 to FIG. 6. FIG. 1 is a diagram illustrating a medical diagnostic imaging apparatus according to a first embodiment. FIG. 2 is a diagram illustrating an exemplary configuration of the medical diagnostic imaging apparatus according to the first embodiment. FIG. 3 is a diagram illustrating an exemplary configuration of a morphological image generating unit according to the first embodiment. FIG. 4 is a diagram illustrating an exemplary configuration of a functional image generating unit according to the first embodiment. FIG. 5 is a diagram illustrating an exemplary configuration of a processing unit according to the first embodiment. FIG. 6 is a diagram illustrating an exemplary configuration of a synthesis unit according to the first embodiment.

The medical diagnostic imaging apparatus 1 includes a couch device 2, a morphological image capturing unit 3, a functional image capturing unit 4, and a console device 5, as illustrated in FIG. 1 and FIG. 2. The first embodiment is described through an exemplary case using an X-ray CT apparatus as the morphological image capturing unit 3 and using a PET apparatus as the functional image capturing unit 4. In the first embodiment, the morphological image capturing unit 3 and the functional image capturing unit 4 capture electrocardiogram (ECG)-synchronized images of the heart of a subject P.

The couch device 2 includes a couchtop 21, a couch 22, a driving device 23, and a signal acquiring unit 24, as illustrated in FIG. 2. The subject P is placed on the couchtop 21. The couchtop 21 is supported by the couch 22. The driving device 23 is positioned inside the couch 22. Under the control of an image-capturing controlling unit 53, which is described later, the driving device 23 moves the couchtop 21 in the Z direction to move the subject P into the inside of an image-capturing opening of the morphological image capturing unit 3 or the functional image capturing unit 4. Here, the Z direction is a direction of the body axis of the subject P. A direction orthogonal to the Z direction within the coronal plane of the subject P is defined as the X direction in FIG. 1 and FIG. 2. Furthermore, a direction orthogonal to the Z direction within the sagittal plane of the subject P is defined as the Y direction in FIG. 1 and FIG. 2. The X direction, the Y direction, and the Z direction form a right-handed system.

The signal acquiring unit 24 acquires a signal from the subject P. In the first embodiment, a signal acquired by the signal acquiring unit 24 is an electrocardiographic signal of the subject P. The signal acquiring unit 24 is, for example, included in an electrocardiographic equipment. Specifically, the signal acquiring unit 24 acquires a weak electronic signal emitted from the heart of the subject P via electrodes attached to the subject P. The signal acquiring unit 24 then outputs an electrocardiographic signal based on the acquired electronic signal to the control unit 58, which is described later. An electrocardiographic signal is described later in detail.

The morphological image capturing unit 3 includes an X-ray tube 31, an X-ray detector 32, a rotating frame 33, and a data collecting unit 34, as illustrated in FIG. 2.

The X-ray tube 31 generates an X-ray applied to the subject P. For example, the X-ray tube 31 generates an X-ray having a beam shape that has irradiation spreading along the X direction and the Z direction. An X-ray that has this beam shape is called a cone beam. The X-ray tube 31 includes a wedge and a collimator. The wedge is an X-ray filter for adjusting the dose of an X-ray applied to the subject P. The collimator is a slit for narrowing a range irradiated with an X-ray, the dose of which has been adjusted by the wedge.

The X-ray detector 32 is a multi-line detector having a plurality of detecting elements arranged in a channel direction and a slice direction. The detecting elements detect the intensity of an X-ray generated by the X-ray tube 31 and applied to the subject P. The channel direction is the circumferential direction of the rotating frame 33. The slice direction is the Z direction. For example, the X-ray detector 32 includes detecting elements, the numbers of which in the channel direction and the slice direction are large enough for collecting volume data of the entire heart of the subject P in one-time execution of conventional scanning.

Each of the detecting elements includes a scintillator, a photodiode, and a detecting circuit. The following is how the detecting element detects the intensity of an X-ray. Initially, the detecting element converts an incident X-ray into light by the scintillator. Subsequently, the detecting element converts the light into an electric charge by the photodiode. The detecting element then converts this electric charge into an electrical signal by the detecting circuit, and outputs the electric signal to the data collecting unit 34, which is described later. A detector that includes detecting elements each including a scintillator and a photodiode is called a solid state detector.

The rotating frame 33 is an annular frame supporting the X-ray tube 31 and the X-ray detector 32 so that they can face each other across the subject P. The rotating frame 33 is driven by the image-capturing controlling unit 53, which is described later, and thereby rotates at high speed in a circular orbit having the subject P at the center thereof.

The data collecting unit 34 generates morphological image base data, based on electric signals output by the detecting elements included in the X-ray detector 32. The morphological image base data is projection data for generating a morphological image. This projection data is, for example, sinograms. A sinogram is data obtained by arraying signals detected by the X-ray detector 32 at each position of the X-ray tube 31. Here, a position of the X-ray tube 31 is called a view. A sinogram is data obtained by assigning intensities of an X-ray detected by the X-ray detector 32 to positions in a two-dimensional orthogonal coordinate system in which a first direction is set to the view direction and a second direction orthogonal to the first direction is the channel direction of the X-ray detector 32. The data collecting unit 34 generates a sinogram with respect to each line in the slice direction. Generated sinograms are transmitted to a morphological image generating unit 54, which is described later. The data collecting unit 34 is also called a data acquisition system (DAS).

The functional image capturing unit 4 includes a γ-ray detector 41 and a simultaneous counting information collecting unit 42, as illustrated in FIG. 2.

The γ-ray detector 41 includes a plurality of detector modules 411. Each of the detector modules 411 is an indirect-conversion detector, which includes a scintillator, a light guide, and a photomultiplier tube (PMT).

The scintillators convert, into visible light, a pair of γ-rays emitted in substantially opposite directions as a result of pair annihilation between a positron contained in a radiopharmaceutical agent administered to the subject P and an electron inside the subject P. Each of the scintillator is formed of, for example, sodium iodide (NaI), bismuth germanate (BGO), lutetium yttrium oxyorthosilicate (LYSO), lutetium oxyorthosilicate (LSO), or lutetium gadolinium oxyorthosilicate (LGSO). A plurality of scintillators are provided in each of the detector modules 411.

The light guide transfers the visible light generated by the scintillators to the photomultiplier tube. The light guide is formed of, for example, a plastic material having excellent optical transparency, such as methyl methacrylate (MMA).

The photomultiplier tube includes a photocathode, a plurality of dynodes, and an anode. The photocathode receives the visible light output from the scintillator, and generates photoelectrons by the photoelectric effect. Each of the dynodes generates an electric field for accelerating the photoelectrons generated by the photocathode. Each of the photoelectrons generated by the photocathode collides with one of the dynodes, and a plurality of electrons are consequently sprung out. Each of the electrons thus sprung out collides with the next one of the dynodes, and a plurality of electrons are consequently sprung out. This phenomenon is repeated a plurality of times, and a large number of electrons enter the anode as a result. The electrons having entered the anode are turned into signaling current, and the signaling current is transmitted to the simultaneous counting information collecting unit 42. Here, signaling current is, for example, analog waveform data.

The plurality of the detector modules 411 described above are arranged into a tube-like shape with the scintillators facing inward, thus forming the γ-ray detector 41.

Each of the detector modules 411 may be a direct-conversion detector provided with a semiconductor element such as cadmium telluride (CdTe). A direct-conversion detector directly converts, into current, a γ-ray having entered the semiconductor element. Current output from the semiconductor element is output at least either from transferring, toward a collecting electrode at a positive potential, of electrons generated by the entrance of the γ-ray or from travelling, toward a collecting electrode at negative potential, of holes generated by the entrance of the γ-ray. The thus output current is transferred as signaling current to the simultaneous counting information collecting unit 42.

Based on signaling current transferred from the detector modules 411 included in the γ-ray detector 41, the simultaneous counting information collecting unit 42 calculates: the positions of the scintillators that have been entered by γ-rays; the energies of the γ-rays having entered the scintillators; and times at which the γ-rays have been detected. The positions of the scintillators entered by a pair of γ-rays, the energies of the γ-rays having entered the scintillators, and the times at which the γ-rays have been detected, which are calculated by the simultaneous counting information collecting unit 42, are called counting information.

The simultaneous counting information collecting unit 42 calculates the positions of the scintillators entered by the γ-rays. Specifically, the simultaneous counting information collecting unit 42 calculates the barycenter thereof, based on: the positions of a plurality of photomultiplier tubes that have converted a plurality of visible light rays into signaling current substantially at the same time, the plurality of visible light rays having been output from the scintillators; and energies of γ-rays corresponding to the intensities of these respective electrical signals. The simultaneous counting information collecting unit 42 then specifies the positions of the scintillators entered by the γ-rays from the calculated position of the barycenter thereof.

The simultaneous counting information collecting unit 42 calculates energies of γ-rays having entered the scintillators. Specifically, the simultaneous counting information collecting unit 42 calculates, as the energies of γ-rays having entered the scintillator, respective wave heights and waveform areas of waveforms contained in waveform data of signaling current output by the photomultiplier tubes.

The simultaneous counting information collecting unit 42 calculates times at which γ-rays have been detected. For example, the simultaneous counting information collecting unit 42 calculates, as a time at which a γ-ray has been detected, an instant at which a current value in waveform data of signaling current exceeds a predetermined threshold. Note that times at which γ-rays have been detected are, for example, absolute times. The absolute times are clock times. Alternatively, times at which γ-rays have been detected may be relative times from a time point at which functional image capturing is started.

The simultaneous counting information collecting unit 42 applies the method described above to each scintillator included in each of the detector modules 411, thus calculating the counting information.

Subsequently, based on the calculated times at which γ-rays have been detected in the calculated counting information, the simultaneous counting information collecting unit 42 searches for two pieces of counting information that correspond to a pair of γ-rays that have been emitted in substantially opposite directions as a result of pair annihilation and detected substantially at the same time. For example, the simultaneous counting information collecting unit 42 collects, as a piece of simultaneous counting information, two pieces of counting information in which the difference in time between the detection is within a certain time window. More specifically, one piece of simultaneous counting information includes two pieces of counting information. Simultaneous counting information is transferred, as functional image base data, that is, projection data for generating a functional image, to a functional image generating unit 55, which is described later. The simultaneous counting information collecting unit 42 may perform the process described above using the time window on counting information within a certain energy window. A line segment connecting two scintillators that have detected one pair of γ-rays generated by pair annihilation is called a line of response (LOR).

The console device 5 includes, as illustrated in FIG. 2, an input unit 51, a display unit 52, the image-capturing controlling unit 53, the morphological image generating unit 54, the functional image generating unit 55, a processing unit 56, a synthesis unit 57, and a control unit 58.

The input unit 51 is included in a mouse, a keyboard, or the like used by a user of the medical diagnostic imaging apparatus 1 to input various instructions and various settings. The input unit 51 transfers instructions and setting information accepted from the user to the control unit 58. The display unit 52 is a monitor to which the user refers. The display unit 52 displays, for example, a graphical user interface (GUI) for accepting various settings from the user via the input unit 51 as a result of image processing of various kinds.

The image-capturing controlling unit 53 controls performances of the couch device 2, the morphological image capturing unit 3, and the functional image capturing unit 4 under the control of the control unit 58. For example, the image-capturing controlling unit 53 performs the following control. While controlling the signal acquiring unit 24 to acquire a signal from the subject P, the image-capturing controlling unit 53 controls the driving device 23 to move the couchtop 21 having the subject P placed thereon into the inside of the image-capturing opening of the morphological image capturing unit 3, to have morphological images of a target region inside the body of the subject P captured. A method for the morphological image capturing is, for example, conventional scanning. Subsequently, while controlling the signal acquiring unit 24 to acquire a signal from the subject P, the image-capturing controlling unit 53 controls the driving device 23 to move the couchtop 21 having the subject P placed thereon into the inside of the image-capturing opening of the functional image capturing unit 4, to have functional images of the target region inside the body of the subject P captured.

The morphological image generating unit 54 includes a preprocessing unit 541, a morphological image base data storing unit 542, a morphological image reconstructing unit 543, and a morphological image storing unit 544, as illustrated in FIG. 3.

The preprocessing unit 541 applies correction processing to the morphological image base data generated by the data collecting unit 34. This correction processing is, for example, logarithmic conversion, offset correction, sensitivity correction, beam hardening correction, or scattered radiation correction. The morphological image base data storing unit 542 stores therein the morphological image base data to which the correction processing has been applied.

The morphological image base data to which the correction processing has been applied by the preprocessing unit 541 is also called raw data. The morphological image base data storing unit 542 stores therein the raw data.

The morphological image reconstructing unit 543 generates morphological images of the target region at different time phases. More specifically, the morphological image reconstructing unit 543 generates a plurality of time-series morphological images of the target region. A morphological image is an image representing morphological information. A morphological image also means the morphological image itself, or data based on which the morphological image is displayed. A morphological image is captured by, for example, an X-ray CT apparatus or a magnetic resonance imaging apparatus. In the first embodiment, a morphological image is a CT image. In the first embodiment, the morphological image reconstructing unit 543 reconstructs morphological image base data stored in the morphological image base data storing unit 542, thereby generating a morphological image.

Examples of a method for the reconstruction include back-projection processing. Examples of back-projection processing include a filtered back-projection (FBP) method. The morphological image reconstructing unit 543 may perform the reconstruction using, for example, successive approximation. The morphological image storing unit 544 stores therein morphological images generated by the morphological image reconstructing unit 543.

The functional image generating unit 55 includes a functional image base data storing unit 551, a functional image reconstructing unit 552, and a functional image storing unit 553, as illustrated in FIG. 4.

The functional image base data storing unit 551 stores therein the simultaneous counting information transferred as functional image base data from the simultaneous counting information collecting unit 42. The functional image reconstructing unit 552 generates functional images of the target region described above. A functional image is an image representing functional information. A functional image means the functional image itself, or data based on which the functional image is displayed. The functional information is, for example, a motion parameter of the target region or a parameter related to a bloodstream. Examples of a motion parameter of the target region include the quantity of myocardial wall motion, and the ejection fraction. Examples of a parameter related to a bloodstream are, for example, a blood flow, a blood volume, a mean transit time, and a washout rate. A functional image is captured by, for example, a nuclear medicine imaging apparatus such as a PET apparatus or a SPECT apparatus. In the first embodiment, a functional image is a PET image. In the first embodiment, the functional image reconstructing unit 552 reconstructs functional image base data stored in the functional image base data storing unit 551, thereby generating a functional image.

Examples of a method for the reconstruction include successive approximation. Examples of successive approximation include a maximum likelihood expectation maximization (MLEM) method and an ordered subset MLEM (OSEM) method. The functional image reconstructing unit 552 may perform the reconstruction using a time-of-flight difference as performed in a time-of-flight (TOF)-PET apparatus. Here, a time-of-flight difference is the difference in time between the detection in the simultaneous counting information. The functional image storing unit 553 stores therein functional images generated by the functional image reconstructing unit 552.

The processing unit 56 includes a morphological image data collecting unit 561, a functional image data collecting unit 562, a displacement calculating unit 563, a correction unit 564, a corrected functional image data storing unit 565, as illustrated in FIG. 5.

The morphological image data collecting unit 561 collects pieces of morphological image data of the target region at a plurality of time phases. Morphological image data means morphological images or morphological image base data. This means that the morphological image data collecting unit 561 collects morphological images from the morphological image storing unit 544. The morphological image data collecting unit 561 also collects morphological image base data from the morphological image base data storing unit 542. The morphological image data collecting unit 561 is described later in detail.

The functional image data collecting unit 562 collects functional image data of the target region. Functional image data means functional images or functional image base data. This means that the functional image data collecting unit 562 collects functional images from the functional image storing unit 553. The functional image data collecting unit 562 collects functional image base data from the functional image base data storing unit 551. The functional image data collecting unit 562 is described later in detail.

The displacement calculating unit 563 calculates displacements of morphological image regions contained in the collected pieces of morphological image data, based on a plurality of the collected pieces of morphological image data. For example, based on two temporarily consecutive pieces of morphological image data among a plurality of pieces of morphological image data that are generated in a time-series manner, the displacement calculating unit 563 calculates displacements of the plurality of morphological image regions. Here, when morphological images are three-dimensional, morphological image regions are three-dimensional regions. When morphological images are two-dimensional, morphological image regions are two-dimensional regions. The displacement calculating unit 563 is described later in detail.

The correction unit 564 generates, based on the displacements calculated by the displacement calculating unit 563, corrected image data corrected for motion of the target region. Corrected image data means corrected images themselves, or data based on which a corrected image is displayed. The correction unit 564 is described later in detail.

The corrected functional image data storing unit 565 stores therein functional image data corrected by the correction unit 564. The morphological image data collecting unit 561, the functional image data collecting unit 562, the displacement calculating unit 563, and the correction unit 564 are described later in detail. The corrected functional image data storing unit 565 is described later in detail.

The synthesis unit 57 includes an image data synthesizing unit 571 and a synthetic functional image data storing unit 572, as illustrated in FIG. 6. In the following description, functional image data obtained by summing brightness levels with respect to each functional image region in functional image data corrected by the correction unit 564 is referred to as summed functional image data.

The image data synthesizing unit 571 generates synthetic functional image data into which a plurality of pieces of corrected image data are synthesized. The image data synthesizing unit 571 generates summed functional image data as synthetic functional image data, by obtaining a weighted sum of brightness levels with respect to each functional image region in a plurality of pieces of functional image data collected by the functional image data collecting unit 562 and generated by the correction unit 564. Here, a functional image region is a region corresponding to a morphological image region in functional image data. Therefore, when the morphological image region is three-dimensional, the functional image region is three-dimensional. When the morphological image region is two-dimensional, the functional image region is two-dimensional.

The synthetic functional image data storing unit 572 stores therein the synthetic functional image data generated by the image data synthesizing unit 571. Synthetic functional image data means a synthetic functional image itself, or data based on which a synthetic functional image is displayed.

Furthermore, the image data synthesizing unit 571 acquires morphological image data from the morphological image storing unit 544. The image data synthesizing unit 571 acquires, from the synthetic functional image data storing unit 572, summed functional image data at times corresponding to the morphological image data acquired from the morphological image storing unit 544. The image data synthesizing unit 571 then generates synthetic functional image data in which a summed functional image is overlaid on a morphological image. In this case, for example, the morphological image is displayed in gray scale, and the summed functional image is displayed in color scale.

Alternatively, the image data synthesizing unit 571 acquires corrected functional image data at times corresponding to the morphological image data acquired from the morphological image storing unit 544. The image data synthesizing unit 571 then generates synthetic functional image data in which a corrected functional image is overlaid on a morphological image. In this case, for example, the morphological image is displayed in gray scale, and the corrected functional image is displayed in color scale.

The control unit 58 controls the medical diagnostic imaging apparatus 1 as a whole. More specifically, the control unit 58 controls the couch device 2, the morphological image capturing unit 3, the functional image capturing unit 4 and the console device 5. The control unit 58 controls the image-capturing controlling unit 53 to collect morphological image base data and functional image base data. The control unit 58 controls the morphological image generating unit 54 to generate morphological image data. The control unit 58 controls the functional image generating unit 55 to generate functional images. The control unit 58 controls the processing unit 56 to generate at least one of corrected functional image and summed functional image data. The control unit 58 controls the synthesis unit 57 to generate synthetic functional image data. The control unit 58 causes the display unit 52 to display thereon any desired one of a morphological image, a functional image, a summed functional image, and a synthetic functional image in accordance with an instruction input by the user via the input unit 51, a previously set condition, or the like.

The morphological image base data storing unit 542 described above, morphological image storing unit 544, functional image base data storing unit 551, functional image storing unit 553, corrected functional image data storing unit 565 and synthetic functional image data storing unit 572 can each be implemented by, for example, a random access memory (RAM), a semiconductor memory element, a hard disk, or an optical disc. The semiconductor memory element is, for example, a flash memory. The image-capturing controlling unit 53, preprocessing unit 541, morphological image reconstructing unit 543, functional image reconstructing unit 552, and control unit 58 described above can each be implemented by an integrated circuit or an electronic circuit. The integrated circuit is, for example, an application specific integrated circuit (ASIC) or a field programmable gate array (FPGA). The electronic circuit is, for example, a central processing unit (CPU) or a micro processing unit (MPU).

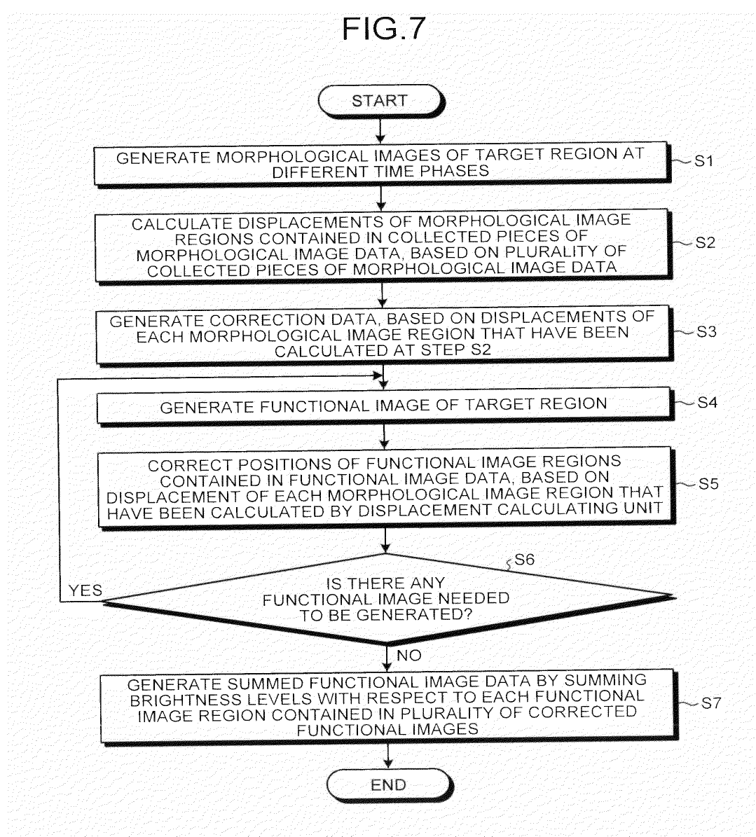

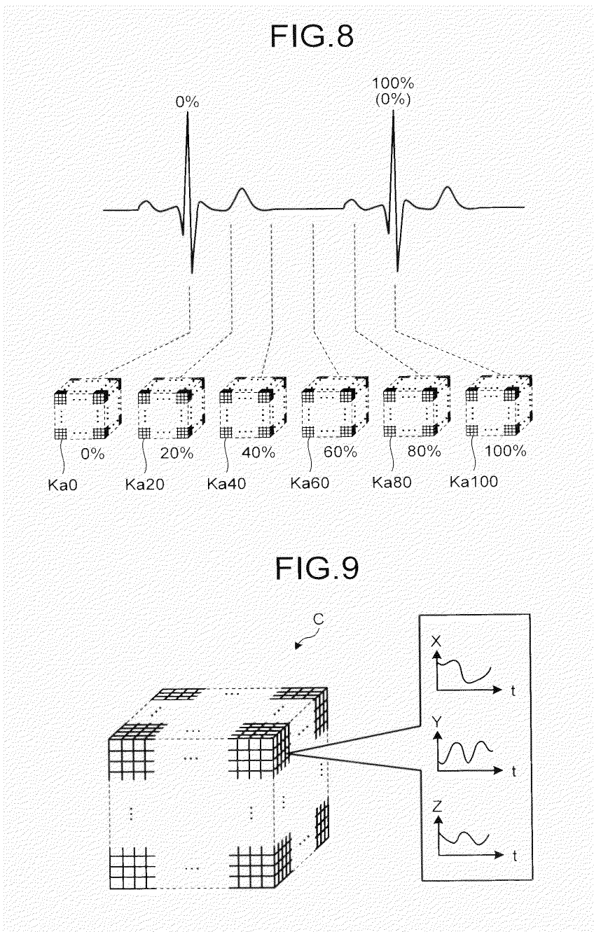

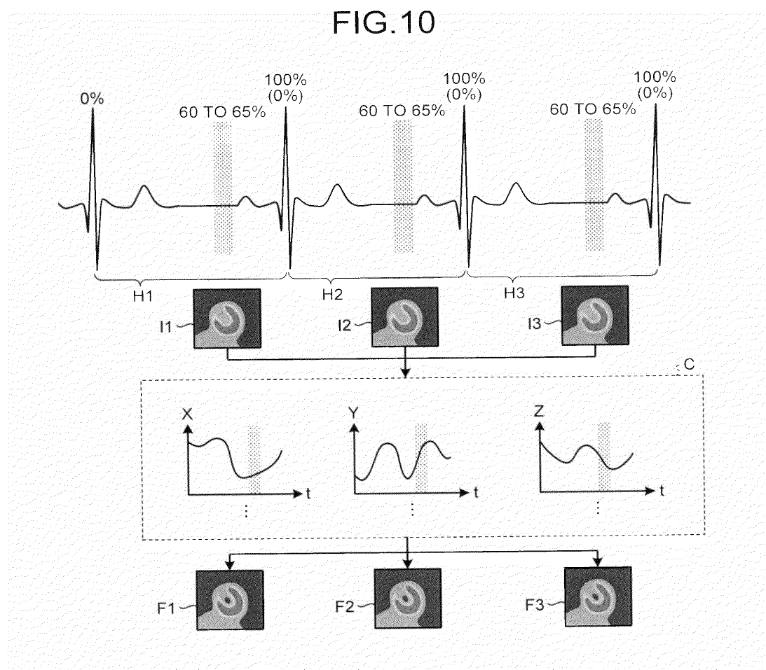

The following describes, with reference to FIG. 7 to FIG. 10, exemplary processing that the medical diagnostic imaging apparatus 1 according to the first embodiment performs. FIG. 7 is a flowchart illustrating exemplary processing in the medical diagnostic imaging apparatus according to the first embodiment. FIG. 8 is a diagram for explaining the relation between morphological images captured by the morphological image capturing unit and a signal obtained by a signal acquiring unit, according to the first embodiment. FIG. 9 is a diagram illustrating correction data produced by a displacement calculating unit according to the first embodiment. FIG. 10 is a diagram for explaining a procedure in accordance with which a correction unit according to the first embodiment corrects the positions of a plurality of functional image regions contained in functional images.

The morphological image reconstructing unit 543 generates morphological images of the target region at different time phases, as illustrated in FIG. 8 (Step S1). Specifically, the morphological image reconstructing unit 543 generates morphological images of the target region using synchronized reconstruction based on a signal acquired from the subject P by the signal acquiring unit 24.

In the beginning, the signal acquiring unit 24 acquires an electrocardiographic signal from the subject P under the control of the image-capturing controlling unit 53. An electrocardiographic signal is a signal representing temporal changes in voltage generated by pulsations of the heart, as illustrated in FIG. 8. In an electrocardiographic signal, as illustrated in FIG. 8, a waveform called an R wave appears in which voltage temporarily surges. FIG. 8 illustrates two R waves. An interval from one R wave to the next R wave corresponds to one pulsation. An interval from one R wave to the next R wave is called an RR interval. Furthermore, as illustrated in FIG. 8, the voltage generated by pulsations of the heart is presented in association with heartbeat phases, the range from 0% to 100% of which corresponds to each RR interval corresponding one heartbeat.

Subsequently, the morphological image capturing unit 3 collects morphological image base data under the control of the image-capturing controlling unit 53. For example, the morphological image capturing unit 3 irradiates the subject P with an X-ray while causing the rotating frame 33 supporting the X-ray tube 31 and the X-ray detector 32 to rotate at a plurality of revolutions during each RR interval. The data collecting unit 34 generates morphological image base data in a plurality of ranges of heartbeat phases in each RR interval. The data collecting unit 34 collects six pieces of morphological image base data, that is, pieces of morphological image base data in respective ranges of ±5% of heartbeat phases of 0%, 20%, 40%, 60%, 80%, and 100%, as illustrated in FIG. 8, for example.

The morphological image reconstructing unit 543 reconstructs the morphological image base data generated by the data collecting unit 34, thereby generating morphological images. For example, the morphological image reconstructing unit 543 reconstructs the six pieces of morphological image base data collected by the data collecting unit 34, thereby generating a morphological image Ka0, a morphological image Ka20, a morphological image Ka40, a morphological image Ka60, a morphological image Ka80, and a morphological image Ka100 of the heart, which are three-dimensional, as illustrated in FIG. 8. The morphological image reconstructing unit 543 can generate two-dimensional morphological images and three-dimensional morphological images.

The morphological image Ka0 is obtained by reconstructing morphological image base data at heartbeat phases of 0%±5%. The morphological image Ka20 is obtained by reconstructing morphological image base data at heartbeat phases of 20%±5%. The morphological image Ka40 is obtained by reconstructing morphological image base data at heartbeat phases of 40%±5%. The morphological image Ka60 is obtained by reconstructing morphological image base data at heartbeat phases of 60%±5%. The morphological image Ka80 is obtained by reconstructing morphological image base data at heartbeat phases of 80%±5%. The morphological image Ka100 is obtained by reconstructing morphological image base data at heartbeat phases of 100%±5%.

The morphological images generated at Step S1 are collected by the morphological image data collecting unit 561. More specifically, the morphological image data collecting unit 561 collects pieces of morphological image data generated by synchronized reconstruction based on a signal acquired from the subject P by the signal acquiring unit 24.

The displacement calculating unit 563 calculates displacements of morphological image regions contained in the collected pieces of morphological image data, based on a plurality of the collected pieces of morphological image data (Step S2). For example, a morphological image region is a pixel in a morphological image. Alternatively, a morphological image region is a region made by combining a plurality of pixels in a morphological image. When the morphological image is three-dimensional, the pixels are three-dimensional. When the morphological image is two-dimensional, the pixels are two-dimensional.

Specifically, the displacement calculating unit 563 sets a morphological image at a certain heartbeat phase as a benchmark, and calculates, based on this morphological image used as a benchmark, displacements of the respective morphological image regions in morphological images at other heartbeat phases. For example, the displacement calculating unit 563 sets the morphological image Ka0 as the benchmark, and calculates displacements of the respective morphological image regions of the morphological image Ka20, the morphological image Ka40, the morphological image Ka60, the morphological image Ka80, and the morphological image Ka100. More specifically, the displacement calculating unit 563 calculates respective positions at which each morphological image region in the morphological image Ka0 is found in the morphological image Ka20, the morphological image Ka40, the morphological image Ka60, the morphological image Ka80, and the morphological image Ka100. The positions of morphological image regions in the morphological image Ka0 serve as benchmarks for the displacements thus calculated by the displacement calculating unit 563.

Furthermore, when calculating displacements of the morphological image regions, the displacement calculating unit 563 applies a registration method to the morphological image data. Alternatively, when calculating displacements of the morphological image regions, the displacement calculating unit 563 applies a point-matching method to the morphological image data.

The size and the shape of each morphological image region are restricted to some extent by the size, the shape, the structure, motion, and the like of the target region. For example, when the target region is the heart while the morphological images are cuboidal, the length of each side of the morphological image region is short to some extent because of the complicated motion of the heart. In contrast, when motion in a certain direction is dominant in motion of the target region, the length of the morphological image region in the certain direction is short to some extent; however, lengths of the morphological image region in other directions are not so rigidly restricted.

The displacement calculating unit 563 generates correction data C, based on the displacements of each morphological image region that have been calculated at Step S2 (Step S3). Specifically, the displacement calculating unit 563 generates the correction data C by associating the calculated displacements of each morphological image region with the heartbeat phases. For example, the displacement calculating unit 563 generates the correction data C in such a manner that the calculated displacements of each morphological image region are arranged in accordance with the order of the heartbeat phases. Alternatively, the displacement calculating unit 563 generates the correction data C by arranging the calculated displacements of each morphological image region in accordance with the order of the heartbeat phases and applying curve approximation thereto. The correction data C represents changes of the X-direction component, Y-direction component, and Z-direction component of each morphological image region over time t, as illustrated in FIG. 9.

The functional image reconstructing unit 552 generates a functional image of the target region (Step S4). Specifically, the functional image reconstructing unit 552 generates functional images of the target region by synchronized reconstruction based on a signal acquired from the subject P by the signal acquiring unit 24.

The functional image capturing unit 4 collects functional image base data under the control of the image-capturing controlling unit 53. It takes longer for the functional image capturing unit 4 to collect functional image base data than for the morphological image capturing unit 3 to collect morphological image base data.

The functional image reconstructing unit 552 reconstructs functional image base data collected by the simultaneous counting information collecting unit 42, thereby generating functional images. For example, the functional image reconstructing unit 552 reconstructs functional image base data between electrocardiographic phases of 60% and 65% in a pulsation H1, in a pulsation H2, and in a pulsation H3, as illustrated in the first row in FIG. 10. By this reconstruction, the functional image reconstructing unit 552 can generate a functional image I1, a functional image I2, and a functional image I3, as illustrated in the second row in FIG. 10. The functional image I1 is a functional image between electrocardiographic phases of 60% and 65% in the pulsation H1. The functional image I2 is a functional image between electrocardiographic phases of 60% and 65% in the pulsation H2. The functional image I3 is a functional image between electrocardiographic phases of 60% and 65% in the pulsation H3. The functional image reconstructing unit 552 can generate two-dimensional functional images and three-dimensional functional images.

The functional image generated at Step S4 is collected by the functional image data collecting unit 562. More specifically, the functional image data collecting unit 562 collects functional image data that have been generated by synchronized reconstruction based on a signal acquired from the subject P by the signal acquiring unit 24.

The correction unit 564 corrects the positions of functional image regions contained in the functional image data, based on the displacements of each morphological image region that have been calculated by the displacement calculating unit 563 (Step S5). Specifically, based on the displacements of morphological image regions at a specific time phase among the displacements of each morphological image region that have been calculated by the displacement calculating unit 563, the correction unit 564 corrects the positions of functional image regions in the functional image data that correspond to morphological image regions, the specific time phase corresponding to the functional image data. For example, the correction unit 564 uses, from the correction data C, portions that correspond to the functional image I1, the functional image I2, and the functional image I3 between electrocardiographic phases of 60% and 65%, as illustrated in the third row in FIG. 10. The correction unit 564 corrects respective functional image regions contained in the functional image I1, the functional image I2, and the functional image I3, by using the portions in the correction data C that correspond to ranges between electrocardiographic phases of 60% and 65%. By this correction, the correction unit 564 generates a functional image F1 illustrated in the fourth row in FIG. 10 from the functional image I1. Likewise, the correction unit 564 generates a functional image F2 illustrated in the fourth row in FIG. 10 from the functional image I2, and generates a functional image F3 illustrated in the fourth row in FIG. 10 from the functional image I3.

For example, a functional image region is a pixel in a functional image. Alternatively, a functional image region is a region made by combining a plurality of pixels in a functional image.

The control unit 58 determines whether there is any functional image needed to be generated (Step S6). If the control unit 58 determines that there is any functional image needed to be generated, the processing returns to Step S4 (Yes at Step S6). If the control unit 58 determines that there is no functional image needed to be generated, the processing proceeds to Step S7 (No at Step S6). Here, the heartbeat phase of the functional image to be generated is the same as the heartbeat phase of the functional image generated at Step S4 by the functional image reconstructing unit 552.

The correction unit 564 generates summed functional image data by summing brightness levels with respect to each functional image region contained in a plurality of corrected functional images (Step S7). The summed functional image data results in sharpened images because the summation has increased the brightness levels of the functional image regions. The summed functional image data results in sharper images when this summation is applied to a higher number of functional images in generation of the summed functional image data. The brightness level of a functional image region increases as the concentration of a radiopharmaceutical agent increases.

The description above provides as an example a case where the morphological image reconstructing unit 543 generates six morphological images and, based on the six morphological images, the displacement calculating unit 563 calculates displacements of each morphological image region, at Step S2 in FIG. 7. However, the embodiment is not limited thereto. For example, while the morphological image reconstructing unit 543 may generate a larger number of morphological images at different heartbeat phases, the displacement calculating unit 563 may calculate displacements of each morphological image region, based on these morphological images. In this case, the correction data produced by the displacement calculating unit 563 serves as data that more precisely represents temporal changes in displacement of the morphological image region.

Optionally, the displacement calculating unit 563 may be configured to focus on two morphological images at adjacent heartbeat phases and calculate a position at which each morphological image region in the morphological image at the smaller heartbeat phase is located in the morphological image at the larger heartbeat phase. For example, the displacement calculating unit 563 focuses on the morphological image Ka0 and the morphological image Ka20 and calculates a position at which each morphological image region in the morphological image Ka0 is located in the morphological image Ka20. The displacement calculating unit 563 can thus calculate the position at which each morphological image region in the morphological image Ka0 at the heartbeat phase of 0% is located when the heartbeat phase is 20%. The displacement calculating unit 563 can perform the same processing on other combinations of morphological images at adjacent heartbeat phases, such as the morphological image Ka20 and the morphological image Ka40. Positions of morphological image regions in a morphological image at the smaller one of adjacent heartbeat phases serve as benchmarks for the displacements thus calculated by the displacement calculating unit 563.

In this case, at Step S5 in FIG. 7, the correction unit 564 corrects the functional image I1, the functional image I2, and the functional image I3 by using, from the correction data C, displacements of a plurality of morphological image regions that have been calculated based on the morphological image Ka60 and the morphological image Ka80.

When the displacement calculating unit 563 alternatively generates the correction data C by arranging calculated displacements of each morphological image region in the order of the heartbeat phases and applying curve approximation thereto, the correction unit 564 may correct positions of functional image regions contained in a functional image by using temporal differentiation of a displacement between heartbeat phases between which the functional image to be corrected has been captured. For example, in the case of correcting positions of functional image regions contained in a functional image at a heartbeat phase of 50%, the correction unit 564 calculates a differential coefficient of a displacement of each morphological image region at the heartbeat phase of 50%, and corrects the positions of the functional image regions contained in the functional image by using the differential coefficient.

The description above provides as an example a case where the processing unit 56 performs the processes from Step S4 to Step S7 for a range of heartbeat phases of 60% and 65%. However, the embodiment is not limited thereto. The processing unit 56 can perform the processes from Step S4 to Step S7 for other heartbeat phases as needed.

As described above, the displacement calculating unit 563 calculates displacements of each morphological image region contained in pieces of morphological image data, based on a plurality of the collected pieces of morphological image data; and the correction unit 564 then corrects the positions of functional image regions contained in functional image data, based on the calculated displacements of each morphological image region. A morphological image is an image that unerringly represents the morphology of the target region. Therefore, the displacement calculating unit 563 can accurately calculate displacements of each morphological image region in a morphological image. Consequently, the correction unit 564 can appropriately correct the position of each functional image region in the functional image, based on displacements of each morphological image region that have been calculated by the displacement calculating unit 563. In the manner described above, the medical diagnostic imaging apparatus 1 according to the first embodiment can generate a functional image that is subject to reduced influence from motion of the target region.

In addition, the correction unit 564 generates summed functional image data by summing brightness levels with respect to each functional image region contained in a plurality of corrected functional images. The medical diagnostic imaging apparatus 1 according to the first embodiment can thus generate summed functional image data that not only is subject to reduced influence from motion of the target region but also is sharp because shortage of brightness is supplemented.

### Second Embodiment

A medical diagnostic imaging apparatus 1 according to a second embodiment is described. In the description of the second embodiment, the same reference signs as those used in the description of the first embodiment are used. In the second embodiment, the morphological image capturing unit 3 and the functional image capturing unit 4 capture respiration-synchronized images of the lungs of a subject P. In the following, detailed descriptions of matters already described in the first embodiment are omitted.

The signal acquiring unit 24 acquires a signal from the subject P. In the second embodiment, a signal acquired by the signal acquiring unit 24 is a respiration signal of the subject P. The signal acquiring unit 24 is, for example, a respiration sensor. Specifically, the signal acquiring unit 24 observes respiratory motion of an abdominal area B of the subject P. For example, the signal acquiring unit 24 observes respiratory motion of the abdominal area B of the subject P by using a laser end-measuring machine. The signal acquiring unit 24 then outputs to the control unit 58 a respiration signal based on a result of the observation of motion of the abdominal area B of the subject P.

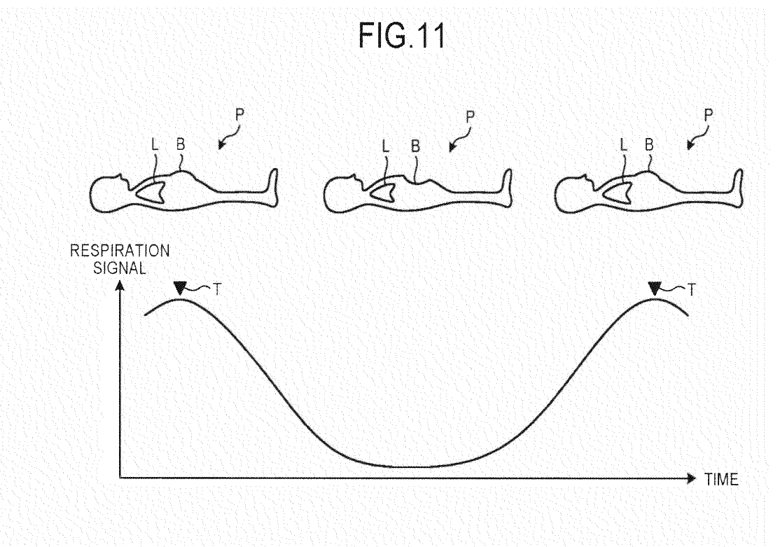

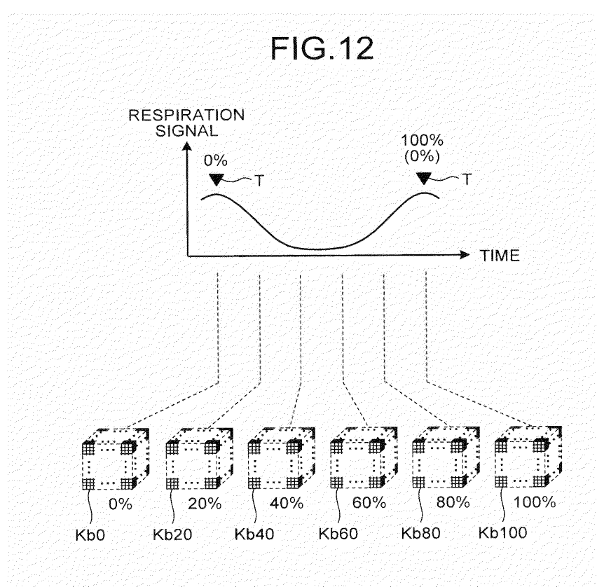

The following describes exemplary processing that the medical diagnostic imaging apparatus 1 according to the second embodiment performs. The following description is given with reference to FIG. 11 and FIG. 12, and, as appropriate, with reference to FIG. 7 used in the description of the first embodiment. FIG. 11 is a diagram for explaining a respiration signal acquired by the signal acquiring unit according to the second embodiment. FIG. 12 is a diagram for explaining the relation between morphological images captured by a morphological image capturing unit according to the second embodiment and a signal obtained by the signal acquiring unit.

In the beginning, the signal acquiring unit 24 acquires a respiration signal from the subject P under the control of the image-capturing controlling unit 53. As illustrated in FIG. 11, the abdominal area B of the subject P expands when the subject P inhales air, and it contracts when the subject P exhales air. The position, the size, the shape, and the like of an internal organ of the subject P change in accordance with such motion of the abdominal area B. For example, each of lungs L of the subject P expands when the subject P inhales air, and it contracts when the subject P exhales air, as illustrated in FIG. 11.

A respiration signal is a signal representing temporal changes in respiratory motion of the abdominal area B, as illustrated in FIG. 11. A respiration signal is high when the subject P inhales air, and it is low when the subject P exhales air, for example, as illustrated in FIG. 11. A time period between when the subject P inhales air and when the subject P inhales the air next time is called a respiration cycle. The respiration cycle changes depending on how the subject P respires, and therefore is not always constant. Likewise, different respiration signals may be acquired from the same subject P in different conditions.

The signal acquiring unit 24 monitors the acquired respiration signal, and outputs a trigger to the control unit 58 at certain timing in each respiration cycle. The signal acquiring unit 24 outputs a trigger T to the control unit 58 when the respiration signal is the highest in each respiration cycle, for example, as illustrated in FIG. 11. The control unit 58 can thus find each respiration cycle contained in the respiration signal. Furthermore, as illustrated in FIG. 11, the respiration signal is presented in association with respiration phases, the range from 0% to 100% of which corresponds to a period from a trigger T to the next trigger T.

The morphological image reconstructing unit 543 generates morphological images of the target region at different time phases, as illustrated in FIG. 12. This process corresponds to Step S1 in FIG. 7. Specifically, the morphological image reconstructing unit 543 generates morphological images of the target region by synchronized reconstruction based on a signal acquired from the subject P by the signal acquiring unit 24.

The morphological image capturing unit 3 collects morphological image base data under the control of the image-capturing controlling unit 53. For example, the morphological image capturing unit 3 irradiates the subject P with an X-ray while causing the rotating frame 33 supporting the X-ray tube 31 and the X-ray detector 32 to rotate at a plurality of revolutions in each respiration cycle. The data collecting unit 34 generates morphological image base data for a range corresponding to a plurality of respiration phases in each respiration cycle. The data collecting unit 34 collects six pieces of morphological image base data, that is, pieces of morphological image base data in respective ranges of ±5% of respiration phases of 0%, 20%, 40%, 60%, 80%, and 100%, for example, as illustrated in FIG. 12.

The morphological image reconstructing unit 543 reconstructs the morphological image base data generated by the data collecting unit 34, thereby generating morphological images. For example, the morphological image reconstructing unit 543 reconstructs the six pieces of morphological image base data collected by the data collecting unit 34, thereby generating a morphological image Kb0, a morphological image Kb20, a morphological image Kb40, a morphological image Kb60, a morphological image Kb80, and a morphological image Kb100 of the lungs L, which are three-dimensional, as illustrated in FIG. 12. These pieces of morphological image data are collected by the morphological image data collecting unit 561. The subsequent processes are the same as those to be performed from Step S2 to Step S7 in FIG. 7.

A method used by the signal acquiring unit 24 to observe motion of the abdominal area B of the subject P is not particularly limited. For example, the signal acquiring unit 24 may use a pressure sensor to observe motion of the abdominal area B of the subject P. In this case, the pressure sensor is arranged between a band wrapped around the abdominal area B of the subject P and the abdominal area B of the subject P. The pressure sensor observes pressure between the band wrapped around the abdominal area B of the subject P and the abdominal area B of the subject P. The signal acquiring unit 24 then outputs a respiration signal based on the observed pressure to the control unit 58.

Alternatively, the signal acquiring unit 24 may use an optical camera to observe motion of the abdominal area B of the subject P. In this case, the optical camera captures images of a reflective material placed on the abdominal area B of the subject P. The signal acquiring unit 24 then observes, based on the images captured by the optical camera, positions of the reflective material and outputs a respiration signal based on a result of the observation to the control unit 58.

Furthermore, a signal acquired from the subject P by the signal acquiring unit 24 may be non-periodic. Even in the case of a non-periodic signal, the displacement calculating unit 563 can calculate displacements of each morphological image region in morphological images generated by the morphological image reconstructing unit 543 so long as the morphological images are associated with the signal.

In the second embodiment, the description provides as an example a case where, while the morphological image reconstructing unit 543 generates morphological images of the lungs L of the subject P, the functional image reconstructing unit 552 generates functional images of the lungs L of the subject P. However, the embodiment is not limited thereto. For example, while the morphological image reconstructing unit 543 may generate morphological images of an abdominal organ, such as the liver, the kidney, or the pancreas, of the subject P, the functional image reconstructing unit 552 may generate functional images of the same target region as the one for which the morphological images are captured.

As described above, the displacement calculating unit 563 calculates displacements of each morphological image region contained in pieces of morphological image data, based on a plurality of pieces among the foregoing pieces of morphological image data; and the correction unit 564 then corrects the positions of functional image regions contained in functional image data, based on the calculated displacements of each morphological image region. A morphological image is an image that unerringly represents the morphology of the target region. Therefore, the displacement calculating unit 563 can accurately calculate displacements of each morphological image region in a morphological image. Consequently, the correction unit 564 can appropriately correct the position of each functional image region in the functional image, based on displacements of each morphological image region that have been calculated by the displacement calculating unit 563. In the manner described above, the medical diagnostic imaging apparatus 1 according to the second embodiment can generate a functional image that is subject to reduced influence from motion of the target region.

In addition, the correction unit 564 generates summed functional image data by summing brightness levels with respect to each functional image region contained in a plurality of corrected functional images. The medical diagnostic imaging apparatus 1 according to the second embodiment can thus generate summed functional image data that not only is subject to reduced influence from motion of the target region but also is sharp because shortage of brightness is supplemented.

### Third Embodiment

A medical diagnostic imaging apparatus 1 according to a third embodiment is described. In the description of the third embodiment, the same reference signs as those used in the description of the first embodiment are used. Each of the medical diagnostic imaging apparatuses 1 according to the first embodiment and the second embodiment corrects the position of a functional image region, in functional image data, that corresponds to a morphological image region, based on a displacement for a time phase corresponding to the functional image data among displacements calculated by the displacement calculating unit 563. In the medical diagnostic imaging apparatus 1 according to the third embodiment, in contrast, corrected image data at any desired time phase is generated in such a manner that: the displacement calculating unit 563 calculates displacements of the target region that correspond to a plurality of time phases, based on pieces of morphological image data at a plurality of time phases; and the correction unit 564 makes correction based on the displacements corresponding to a plurality of time phases. In the following, detailed descriptions of matters already described in the first embodiment or the second embodiment are omitted.

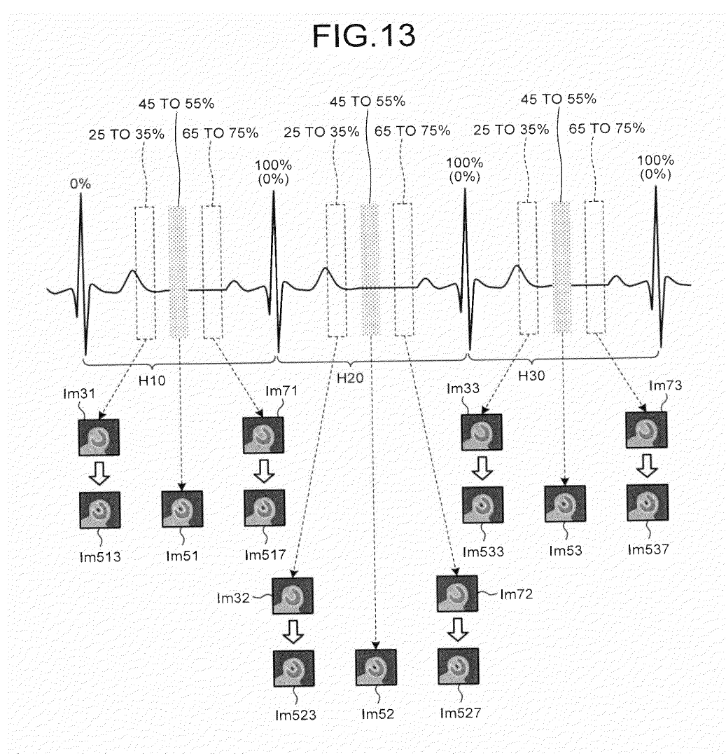

The following describes exemplary processing that the medical diagnostic imaging apparatus 1 according to the third embodiment performs. FIG. 13 is a diagram for explaining a procedure in accordance with which a correction unit according to the third embodiment generates corrected image data.

The functional image reconstructing unit 552 generates functional images of the target region. Specifically, the functional image reconstructing unit 552 generates functional images of the target region by synchronized reconstruction based on a signal acquired from a subject P by the signal acquiring unit 24.

The functional image reconstructing unit 552 reconstructs functional image base data collected by the simultaneous counting information collecting unit 42, thereby generating functional images. For example, the functional image reconstructing unit 552 reconstructs functional image base data between electrocardiographic phases of 25% and 35% in a pulsation H10, in a pulsation H20, and in a pulsation H30, as illustrated in FIG. 13. The functional image reconstructing unit 552 can thus generate a functional image Im31, a functional image Im32, and a functional image Im33. The functional image Im31 is a functional image between electrocardiographic phases of 25% and 35% in the pulsation H10. The functional image Im32 is a functional image between electrocardiographic phases of 25% and 35% in the pulsation H20. The functional image Im33 is a functional image between electrocardiographic phases of 25% and 35% in the pulsation H30.

The functional image reconstructing unit 552 reconstructs functional image base data between electrocardiographic phases of 45% and 55% in the pulsation H10, in the pulsation H20, and in the pulsation H30, as illustrated in FIG. 13. The functional image reconstructing unit 552 can thus generate a functional image Im51, a functional image Im52, and a functional image Im53. The functional image Im51 is a functional image between electrocardiographic phases of 45% and 55% in the pulsation H10. The functional image Im52 is a functional image between electrocardiographic phases of 45% and 55% in the pulsation H20. The functional image Im53 is a functional image between electrocardiographic phases of 45% and 55% in the pulsation H30.

The functional image reconstructing unit 552 reconstructs functional image base data between electrocardiographic phases of 65% and 75% in the pulsation H10, in the pulsation H20, and in the pulsation H30, as illustrated in FIG. 13. The functional image reconstructing unit 552 can thus generate a functional image Im71, a functional image Im72, and a functional image Im73. The functional image Im71 is a functional image between electrocardiographic phases of 65% and 75% in the pulsation H10. The functional image Im72 is a functional image between electrocardiographic phases of 65% and 75% in the pulsation H20. The functional image Im73 is a functional image between electrocardiographic phases of 65% and 75% in the pulsation H30. The functional image reconstructing unit 552 can generate two-dimensional functional images and three-dimensional functional images.

The correction unit 564 corrects, based on the displacements corresponding to a plurality of time phases, functional image data collected at a plurality of time phases, thereby generating a plurality of pieces of corrected image data that correspond to any desired time phase. Specifically, the correction unit 564 generates a functional image Im513 from the functional image Im31 by using a portion of the correction data C that corresponds to electrocardiographic phases of 25% to 35% and another portion of the correction data C that corresponds to electrocardiographic phases of 45% to 55%, as illustrated in FIG. 13. More specifically, the correction unit 564 corrects the position of each functional image region contained in the functional image Im31, thereby generating the functional image Im513 from the functional image Im31. The functional image Im513 is a functional image corresponding to electrocardiographic phases of 45% to 55% in the pulsation H10. The correction unit 564 generates a functional image Im523 from the functional image Im32 and generates a functional image Im533 from the functional image Im33 in the similar manner, as illustrated in FIG. 13. The functional image Im523 is a functional image corresponding to electrocardiographic phases of 45% to 55% in the pulsation H20. The functional image Im533 is a functional image corresponding to electrocardiographic phases of 45% to 55% in the pulsation H30.

The correction unit 564 generates a functional image Im517 from the functional image Im71 by using a portion of the correction data C that corresponds to electrocardiographic phases of 45% to 55% and another portion of the correction data C that corresponds to electrocardiographic phases of 65% to 75%, as illustrated in FIG. 13. Specifically, the correction unit 564 corrects the position of each functional image region contained in the functional image Im71, thereby generating the functional image Im517 from the functional image Im71. The functional image Im517 is a functional image corresponding to electrocardiographic phases of 45% to 55% in the pulsation H10. The correction unit 564 generates a functional image Im527 from the functional image Im72 and generates a functional image Im537 from the functional image Im73 in the similar manner, as illustrated in FIG. 13. The functional image Im527 is a functional image corresponding to electrocardiographic phases of 45% to 55% in the pulsation H20. The functional image Im537 is a functional image corresponding to electrocardiographic phases of 45% to 55% in the pulsation H30.

The image data synthesizing unit 571 may generate synthetic functional image data into which corrected image data are synthesized. For example, with respect to a plurality of pieces of functional image data collected by the functional image data collecting unit 562 and generated by the correction unit 564, the image data synthesizing unit 571 may obtain a weighted sum of brightness levels with respect to each functional image region, and thereby generate summed functional image data as the synthetic functional image data. For example, the image data synthesizing unit 571 generates summed functional image data as the synthetic functional image data by summing brightness levels of each functional image region in at least two images of the functional image Im51, the functional image Im52, the functional image Im53, the functional image Im513, the functional image Im523, the functional image Im533, the functional image Im517, the functional image Im527, and the functional image Im537. Alternatively, the image data synthesizing unit 571 generates summed functional image data as the synthetic functional image data by obtaining a weighted sum of these functional images. In this case, any desired weights are assigned by the image data synthesizing unit 571 to the respective functional images.

In the example described with reference to FIG. 13, the correction unit 564 generates functional images and summed functional image data that correspond to electrocardiographic phases of 45% to 55%. However, the embodiment is not limited thereto. The correction unit 564 can generate a functional image and summed functional image data that correspond to any electrocardiographic phases, based on functional images at any electrocardiographic phases.

As described above, the correction unit 564 corrects, based on the displacements corresponding to a plurality of time phases, functional image data collected at a plurality of time phases and thereby generates a plurality of pieces of corrected image data that correspond to any desired time phase. Additionally, the synthesis unit 57 generates synthetic functional image data into which the plurality of pieces of corrected image data are synthesized. More specifically, the medical diagnostic imaging apparatus 1 according to the third embodiment generates, based on pieces of functional image data at certain phases, pieces of functional image data at another phase, and generates synthetic functional image data by using a plurality of the pieces of functional image data at this other phase. Therefore, the medical diagnostic imaging apparatus 1 according to the third embodiment can reduce a time taken to collect functional image base data.

In the first embodiment, the second embodiment and the third embodiment, the description provides as an example a case where, while the morphological image capturing unit 3 is an X-ray CT apparatus, the functional image capturing unit 4 is a PET apparatus. However, the embodiments are not limited thereto. For example, the morphological image capturing unit 3 may be a magnetic resonance imaging apparatus. Additionally, the functional image capturing unit 4 may be a nuclear medicine imaging apparatus such as a SPECT apparatus.

Morphological image data generated by the morphological image reconstructing unit 543 are not necessarily needed to be generated by synchronized reconstruction based on a signal acquired from the subject P. More specifically, the morphological image reconstructing unit 543 may only need to simply generate morphological image data of the target region at different time phases.

In the description above, the morphological image data collecting unit 561 collects morphological images from the morphological image storing unit 544. However, the embodiments are not limited thereto. The morphological image data collecting unit 561 may collect previously captured morphological images from a device or a storage medium other than the morphological image storing unit 544. In the description above, the morphological image data collecting unit 561 collects morphological image base data from the morphological image base data storing unit 542. However, the embodiments are not limited thereto. The morphological image data collecting unit 561 may collect previously generated morphological images from a device or a storage medium other than the morphological image storing unit 544.

In the description above, the functional image data collecting unit 562 collects functional images from the functional image storing unit 553. However, the embodiments are not limited thereto. The functional image data collecting unit 562 may collect previously captured functional images from a device or a storage medium other than the functional image storing unit 553. In the description above, the functional image data collecting unit 562 collects functional image base data from the functional image base data storing unit 551. However, the embodiments are not limited thereto. The functional image data collecting unit 562 may collect previously generated functional images from a device or a storage medium other than the functional image storing unit 553.

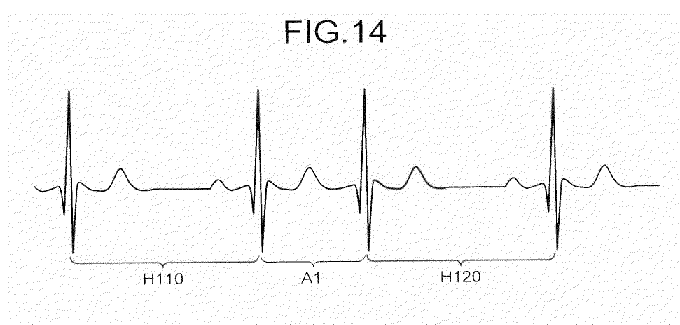

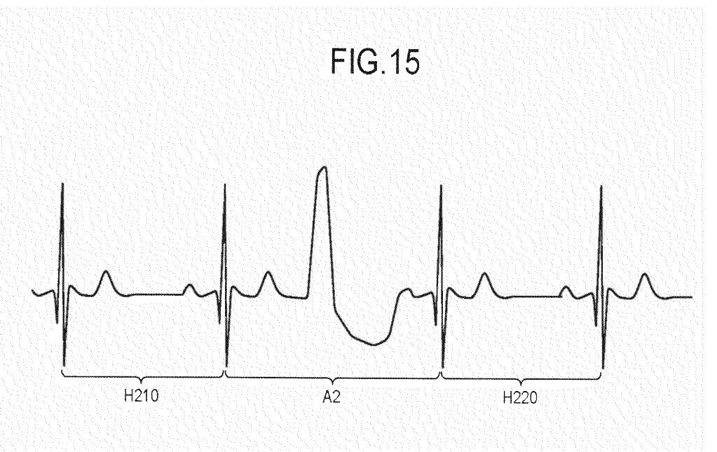

The displacement calculating unit 563 may calculate displacements of morphological image regions contained in morphological image data without using morphological image data collected at time phases when the periodicity of the signal acquired by the signal acquiring unit 24 is being lost. Furthermore, the correction unit 564 may exclude, from data to be corrected for motion of the target region, functional image data collected at time phases when the periodicity of the signal acquired by the signal acquiring unit 24 is being lost. Examples of a case when the periodicity is lost in the signal acquired by the signal acquiring unit 24 include FIG. 14 and FIG. 15.

FIG. 14 is a diagram illustrating one example of a singularly changed electrocardiographic signal. The signal acquiring unit 24 calculates the average of time intervals between adjacent R waves. Normal time intervals between adjacent R waves fall within a certain range that includes this average. Heartbeats with normal time intervals between adjacent R waves are called normal heartbeats. A pulsation H110 and a pulsation H120 illustrated in FIG. 14 are normal heartbeats. Heartbeats with abnormal time intervals between adjacent R waves are called abnormal heartbeats. A pulsation A1 illustrated in FIG. 14 is an abnormal heartbeat. A time interval between adjacent R waves for the pulsation A1 is shorter than time intervals between adjacent R waves for the pulsation H110 and the pulsation H120.

The displacement calculating unit 563 calculates displacements of morphological image regions contained in morphological image data without using morphological image data collected, for example, during the pulsation A1. Additionally, the displacement calculating unit 563 calculates displacements of morphological image regions contained in morphological image data by using, for example, morphological image data collected by continuation of X-ray irradiation during the pulsation H120.

Furthermore, when the morphological image capturing unit 3 generates morphological image data of the heart of the subject P at a certain heartbeat phase by segment reconstruction, morphological image base data collected during the pulsation A1 is not usable in generation of the morphological image data. In this case, the morphological image generating unit 54 collects, during another pulsation, morphological image base data from the same views as a view from which morphological image base data during the pulsation A1 is supposed to be collected. The displacement calculating unit 563 then calculates displacements of morphological image regions contained in morphological image data by using morphological image data generated from the morphological image base data collected during that other pulsation.

The correction unit 564 excludes, for example, functional image data collected during the pulsation A1 from data to be corrected for motion of the target region.

FIG. 15 is a diagram illustrating another example of a singularly changed electrocardiographic signal. A pulsation H210 and a pulsation H220 illustrated in FIG. 15 are normal heartbeats. A pulsation A2 illustrated in FIG. 15 is an abnormal heartbeat. A time interval between adjacent R waves for the pulsation A2 is longer than time intervals between adjacent R waves for the pulsation H210 and the pulsation H220. In addition, there is a premature ventricular contraction (PVC) occurring during the pulsation A2.

The displacement calculating unit 563 and the correction unit 564 can apply to the pulsation A2 the same processes as those applied to the pulsation A1.

When the functional image capturing unit 4 is a TOF-PET apparatus, the correction unit 564 may correct, based on the correction data C, positions at which γ-rays have been generated, instead of correcting, based on the correction data C, positions of each functional image region contained in functional images. More specifically, the correction unit 564 may correct, based on the correction data C, positions at which γ-rays have been generated.

The correction unit 564 can make the correction described above on two-dimensional morphological image data and three-dimensional morphological image data. However, the target region inside the body of the subject P makes motion in all of the X direction, the Y direction, and the Z direction, correction in the X direction, the Y direction, and the Z direction is needed even when the correction is made to two-dimensional morphological image data.

In the first embodiment, the second embodiment, and the third embodiment, the displacement calculating unit 563 calculates displacements for all of morphological image regions contained in morphological images. However, the embodiments are not limited thereto. The displacement calculating unit 563 may calculate displacements with respect to the morphological image regions that are contained in a region of interest defined on morphological images. The region of interest is defined, for example, based on an instruction input by a user with the input unit 51 after the user has referred to a morphological image on the display unit 52. For three-dimensional morphological data, the target region is a two-dimensional region or a three-dimensional region.

When making the correction at Step S5 above, the correction unit 564 according to the first embodiment and the correction unit 564 according to the second embodiment may use correction data used in the past for the same subject P. Alternatively, when making the correction at Step S5 above, the correction unit 564 according to the first embodiment and the correction unit 564 according to the second embodiment may use, for example, applicable correction data used in the past for another subject, or correction data previously prepared through simulation or another method.

The image processing method described above may be performed by an image processing apparatus provided independently of the medical diagnostic imaging apparatus. For example, an image processing apparatus having the same functionality as that of the console device 5 illustrated in FIG. 2 may implement the image processing method described above using morphological image base data and functional image base data acquired from a database in the medical diagnostic imaging apparatus or a picture archiving and communication system (PACS) or from a database in an electronic health record system. Alternatively, an image processing apparatus having the same functionality as that of the console device 5 illustrated in FIG. 2 may implement the image processing method described above using morphological images and functional images acquired from a database in the medical diagnostic imaging apparatus or a picture archiving and communication system (PACS) or from a database in an electronic health record system.

The respective components described in the descriptions above are functionally conceptual, and do not necessarily need to be configured physically as illustrated in the drawings. That is, the specific forms of distribution or integration of the respective components are not limited to the illustrated ones, and the whole or a part thereof can be configured by being functionally or physically distributed or integrated in any form of units, depending on various types of loads, usage conditions, and the like. Furthermore, the whole of or a part of the various processing functions performed in the respective components is implemented by a CPU and a computer program executed by the CPU. Alternatively, the whole of or a part of the various processing functions performed in the respective components is implemented as hardware by wired logic.

The image processing method described in the embodiments described above can be implemented by executing, on a computer such as a personal computer or a workstation, an image processing program prepared in advance. This image processing program can be distributed via a network such as the Internet. This image processing program can also be recorded on a computer-readable recording medium such as a hard disk, a flexible disk (FD), a compact disc read only memory (CD-ROM), a magnetic optical disc (MO), or a digital versatile disc (DVD), and executed by being read out from the recording medium by the computer.

According to at least one of the embodiments described above, functional image data subject to reduced influence from motion of a target region can be generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical diagnostic imaging apparatus comprising:
morphological image data collecting circuitry configured to collect pieces of morphological image data of a target region at a plurality of time phases;
displacement calculating circuitry configured to calculate, based on a plurality of the collected pieces of morphological image data, displacements of morphological image regions contained in the collected pieces of morphological image data;
functional image data collecting circuitry configured to collect functional image data of the target region; and
correction circuitry configured to generate, based on the displacements calculated by the displacement calculating circuitry, corrected image data obtained by correcting the functional image data for motion of the target region.

2. The medical diagnostic imaging apparatus according to claim 1, wherein, based on displacements corresponding to a specific time phase among the displacements calculated by the displacement calculating circuitry, the correction circuitry corrects positions of functional image regions in the functional image data, the specific time phase corresponding to the functional image data, each of the functional image regions corresponding to each of the morphological image regions.

3. The medical diagnostic imaging apparatus according to claim 2, further comprising:
synthesis circuitry configured to generate synthetic functional image data into which a plurality of pieces of corrected image data are synthesized.

4. The medical diagnostic imaging apparatus according to claim 3, wherein the synthesis circuitry generates summed functional image data as the synthetic functional image data by obtaining a weighted sum of brightness levels with respect to each of the functional image regions in a plurality of the collected pieces of functional image data, that have been collected by the functional image data collecting circuitry and generated by the correction circuitry.

5. The medical diagnostic imaging apparatus according to claim 1, wherein
the displacement calculating circuitry calculates displacements of the target region, based on the pieces of morphological image data that correspond to a plurality of time phases, and
the correction circuitry generates corrected image data corresponding to any desired time phase, by making the correction based on the displacements corresponding to the time phases.

6. The medical diagnostic imaging apparatus according to claim 5, wherein
the correction circuitry corrects the a plurality of pieces of functional image data that have been collected at a plurality of time phases, based on the displacements corresponding to the time phases, and generates pieces of the corrected image data that correspond to the desired time phase, and
the medical diagnostic imaging apparatus further comprises synthesis circuitry configured to generate synthetic functional image data into which a plurality of the generated pieces of corrected image data are synthesized.

7. The medical diagnostic imaging apparatus according to claim 6, wherein the synthesis circuitry generates, as the synthetic functional image data, summed functional image data by obtaining a weighted sum of brightness levels with respect to individual functional image regions in the pieces of functional image data that have been collected by the functional image data collecting circuitry and generated by the correction circuitry, the functional image regions corresponding to the morphological image regions.

8. The medical diagnostic imaging apparatus according to claim 2, wherein each of the morphological image regions is a pixel in the morphological image data, and each of the functional image regions is a pixel in the functional image data.

9. The medical diagnostic imaging apparatus according to claim 7, wherein each of the morphological image regions is a pixel in the morphological image data, and each of the functional image regions is a pixel in the functional image data.

10. The medical diagnostic imaging apparatus according to claim 2, wherein each of the morphological image regions is a region made by combining a plurality of pixels in the morphological image data, and each of the functional image regions is a region made by combining a plurality of pixels in the functional image data.

11. The medical diagnostic imaging apparatus according to claim 7, wherein each of the morphological image regions is a region made by combining a plurality of pixels in the morphological image data, and each of the functional image regions is a region made by combining a plurality of pixels in the functional image data.

12. The medical diagnostic imaging apparatus according to claim 1, wherein, when calculating the displacements of the morphological image regions, the displacement calculating circuitry applies a registration method to the morphological image data.

13. The medical diagnostic imaging apparatus according to claim 1, wherein, when calculating the displacements of the morphological image regions, the displacement calculating circuitry applies a point-matching method to the morphological image data.

14. The medical diagnostic imaging apparatus according to claim 1, further comprising:
signal acquiring circuitry configured to acquire a signal from a subject, wherein
the morphological image data collecting circuitry collects the pieces of morphological image data generated by synchronized reconstruction based on the signal, and the functional image data collecting circuitry collects the functional image data generated by synchronized reconstruction based on the signal.

15. The medical diagnostic imaging apparatus according to claim 14, wherein the signal is an electrocardiographic signal of the subject.

16. The medical diagnostic imaging apparatus according to claim 14, wherein the signal is a respiration signal of the subject.

17. The medical diagnostic imaging apparatus according to claim 14, wherein the correction circuitry excludes, from data to be corrected for motion of the target region, functional image data collected at a time phase when periodicity of the signal is being lost.

18. The medical diagnostic imaging apparatus according to claim 1, wherein the displacement calculating circuitry calculates the displacements with respect to the morphological image regions that are contained in a region of interest defined on the morphological image data.

19. An image processing apparatus comprising:
morphological image data collecting circuitry configured to collect pieces of morphological image data of a target region at a plurality of time phases;
displacement calculating circuitry configured to calculate, based on a plurality of the collected pieces of morphological image data, displacements of morphological image regions contained in the collected pieces of morphological image data;
functional image data collecting circuitry configured to collect functional image data of the target region; and
correction circuitry configured to generate, based on the displacements calculated by the displacement calculating circuitry, corrected image data obtained by correcting the functional image data for motion of the target region.

20. An image processing method comprising:
collecting pieces of morphological image data of a target region at a plurality of time phases by morphological image data collecting circuitry;
based on a plurality of the collected pieces of morphological image data, calculating displacements of morphological image regions contained in the collected pieces of morphological image data, by displacement calculating circuitry;
collecting the functional image data of the target region by functional image data collecting circuitry; and
based on the displacements calculated by the displacement calculating circuitry, generating corrected image data obtained by correcting the functional image data for motion of the target region, by correction circuitry.
